(19) United States
(12) Patent Application Publication
(10) Pub. No.: US 2004/0071486 A1
(43) Pub. Date: Apr. 15, 2004

(54) Image reading apparatus and image forming apparatus provided with the same

(75) Inventors: Kenichi Manabe, Tokyo (JP); Michiro Koike, Chiba (JP); Kazuyuki Iwamoto, Chiba (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/663,833

(22) Filed: Sep. 17, 2003

(30) Foreign Application Priority Data
Sep. 24, 2002 (JP) 2002-278052

(51) Int. Cl. G03G 15/00

(52) U.S. Cl. 399/367

(57) ABSTRACT

Originals fed out by a feeder provided above an original supporting portion for movement toward and away from the originals placed on the original supporting portion are separated by a separating portion and fed one by one toward an image reader. A regulator provided between the separating portion and the feeder is then moved to a retracted position in which it does not hamper the feeding of the originals, by an interlocking member, in operative association with the movement of the feeder to a feeding position in which it contacts with the originals when it feeds out the originals. Also, by the interlocking member, the regulator is moved to a regulating position in which it regulates the originals placed on the original supporting portion coming to the separating portion before the feeding operation by the feeder, in operative association with the movement of the feeder to a feeding stop position in which it becomes spaced apart from the originals.

### BACKGROUND OF THE INVENTION

1. Field of the Invention

The invention relates to an image reading apparatus and an image forming apparatus provided with the same, and particularly to an image reading apparatus provided with regulating means for regulating an original placed on an original supporting portion coming to a separating portion before a feeding operation. More particularly, the invention relates to an image reading apparatus provided with regulating means, which is inexpensive and compact and improved in a jam treating property, and an image forming apparatus provided with the same.

2. Related Background Art

Image forming apparatuses such as a digital copying machine, a printer and a facsimile apparatus include an image forming apparatus provided with an image forming portion and an image reading apparatus for reading an original, and designed to form an image on the basis of image information read by the image reading apparatus.

As such an image reading apparatus, there is one which effects, besides book original reading, i.e., reading an original by moving image reading means from left to right and scanning the original with a book original placed on original glass, the reading of the image of an original by stopping the image reading means, and moving the original in a sub-scanning direction by an automatic document feeder (ADF) in this state, i.e., the so-called flow reading.

FIG. 10 of the accompanying drawings schematically shows the construction of a conventional image reading apparatus of such a construction, and this image reading apparatus, as shown in FIG. 10, is provided with an original feeder 500 and a reading housing portion 600. In this reading housing portion 600, there is provided a contact-type image sensor 601 for applying light from an LED array as a light source for illuminating an original to the image information surface of the original, causing reflected light reflected by the image information surface to be imaged on a sensor element by a SELFOC lens (trademark) and reading the image information.

This contact-type image sensor 601 is moved from left to right during the reading of a book original to thereby scan the book original placed on original glass 501, and is stopped at a predetermined reading position when a sheet original conveyed by the document feeder 500 is to be read by flow reading.

Also, the original feeder 500 is provided with an original tray 502 on which originals are placed, a pickup roller 503 provided at a location opposed to an upper original on the original tray 502, and a separating portion provided downstream of the pickup roller 503 and comprising a separating pad 504 and a separating roller 505. The pickup roller 503 is held for movement toward and away from the original by an arm 520 provided for pivotal movement about the center of rotation of the separating roller 505.

Further, the original feeder 500 is provided with a pair of registration rollers 506 and 507 provided downstream of the separating roller 505, a platen roller 508 provided downstream of the pair of registration rollers 506 and 507, a pair of conveying rollers 509 and 510 provided downstream of the platen roller 508, and a pair of sheet discharging rollers 511 and 512 for discharging the original. Design is made such that the original can be conveyed while being urged against the glass stand 501 of the reading housing portion 600 by the platen roller 508.

Each roller is adapted to be rotated by drive from a driving motor (not shown) being transmitted by a gear train or a timing belt, and for example, design is made such that drive is transmitted to the pickup roller 503 and the separating roller 505 through a one-way clutch (not shown) during the forward rotation of the driving motor, and the drive of the driving motor is transmitted to the registration roller 507, the platen roller 508, the conveying roller 509 and the sheet discharging roller 511 through a one-way clutch during the reverse rotation of the driving motor.

Description will now be made of the flow reading operation of the image reading apparatus of such a construction.

Originals are set on the original tray 502 with the image surfaces thereof facing down, and a start button (not shown) is depressed, whereupon the driving motor (not shown) is rotated in a forward direction, whereby the pickup roller 503 retracted upwardly so as not to strike against the originals during the setting of the originals is lowered and comes into contact with the originals, whereafter the pickup roller 503 is rotated in an original conveying direction and conveys the originals to the separating portion 504, 505. The originals are separated one by one by the separating portion 504, 505, and the separated original is dashed against the pair of registration rollers 506 and 507, which are at a halt.

Thereafter, the driving motor is rotated in the forward direction for a predetermined time and the original is looped so that the skew feeding of the original is corrected, and then the driving motor is stopped. Thereby, the original hits against the pair of registration rollers 506 and 507 and is stopped in that state.

Next, the driving motor is rotated in a reverse direction and the registration roller 507 is rotated, whereby the original is conveyed to the platen roller 508, and the reading of the original is effected by the contact-type image sensor with the original brought into close contact with the glass stand 501. When the original passes the platen roller 508, reading is terminated and the original is discharged onto a sheet discharging tray 518 by the pair of conveying rollers 509 and 510 and the pair of sheet discharging rollers 511 and 512.

When the original is thus discharged onto the sheet discharging tray, the driving motor is again rotated in the forward direction. Thereby, the next original is fed, whereafter reading is effected as described above, and this is continued until the originals become exhausted.

Now, in order to prevent the leading edges of the originals from rushing into the separating portion 504, 505 in the form of a bundle during the setting of the originals, a shutter 513 which is regulating means is provided between the pickup roller 503 and the separating portion 504, 505. This shutter 513 is adapted to be moved to a regulating position shown in FIG. 10 in which it regulates the original rushing into the separating portion 504, 505 before the reading operation is started, and a retracted position in which it does not hamper the feeding of the original when the original is fed out to the separating portion 504, 505 by the pickup roller 503.

This shutter 513 is adapted to be selectively moved to the regulating position and the retracted position by a solenoid 514 and a link 515. That is, the original feeder 500 of such a construction has, as driving means, a driving motor for driving the pickup roller 503 and the separating roller 505, and a solenoid 514 for moving up and down the shutter 513.

On the other hand, the pickup roller 503, the separating roller 505 and the shutter 513 are supported by an openable and closable cover 516 pivotably movable in a clockwise direction about a sheet feeding drive shaft 517, and when this openable and closable cover 516 is upwardly pivotally moved and opened, the pad 504 and the separating roller 505 are adapted to be spaced apart from each other. Thereby, if the openable and closable cover 516 is opened when the original is jammed in the separating portion 504, 505, the pad 504 and the separating roller 505 become spaced apart from each other and the jammed original can be removed.

As another construction, there is proposed, for example, in Japanese Patent Application Laid-Open No. 11-143139, a construction which has a driving motor and two lines of transmitting mechanisms for dividing and transmitting the driving force of this driving motor to thereby disuse driving means (such as a solenoid) exclusively for a shutter, and performs the operation of moving up and down a pickup roller and the operation of moving up and down the shutter by a single driving means.

In such a conventional image reading apparatus, however, the shutter 513, the pickup roller 503 and the separating roller 505 are driven by discrete driving means and therefore, not only the number of parts is increased, but also an expensive electrical part such as a solenoid is necessary, and control becomes complicated. Further, a space for mounting the solenoid therein becomes necessary, and the problem of the bulkiness of the image reading apparatus also arises.

Also, in a case where as shown in Japanese Patent Application Laid-Open No. 11-143139, the shutter, the pickup roller and the separating roller are driven by a single driving motor, two transmitting mechanisms, i.e., a drive transmitting mechanism for transmitting the drive of the driving motor to thereby drive the pickup roller and the separating roller, and a drive transmitting mechanism for performing the operation of moving up and down the shutter, become necessary and therefore, the construction of the apparatus becomes complicated and also, a number of parts become necessary. Again in this case, there are the problem of an increased cost and the problem of the bulkiness of the image reading apparatus attributable to the disposition of the drive transmitting mechanisms.

On the other hand, when as already described, sheet jam occurs, the openable and closable cover is opened, whereafter the jammed original is pulled out, but when the openable and closable cover is being thus opened, the shutter may hang down from gravity. If the shutter thus hangs down, not only the shutter may be caught by the original and may hinder the pulling-out of the original, but also may impart damage to the original.

### SUMMARY OF THE INVENTION

So, the present invention has been made in view of such a situation and has as its object to provide an image reading apparatus provided with a shutter (regulating means) which is inexpensive and compact and improved in a jam treating property, and an image forming apparatus provided with the same.

In order to achieve the above object, in an image reading apparatus according to the present invention provided with image reading means for reading the images of originals, and an original feeder for feeding the originals from an original supporting portion on which the originals are placed to the image reading means, the original feeder is provided with feeding means provided above the original supporting portion for movement toward and away from the originals placed on the original supporting portion and for feeding out the originals, a separating portion for separating the originals fed out by the feeding means and feeding them one by one to the image reading means, regulating means provided between the separating portion and the feeding means and movable to a regulating position in which it regulates the originals placed on the original supporting portion coming to the separating portion before the feeding operation by the feeding means, and a retracted position in which it does not hamper the feeding of the originals during the feeding operation of the feeding means, interlocking means for moving the regulating means to the retracted position in operative association with the movement of the feeding means to a feeding position in which it contacts with the originals when the feeding means feeds out the originals, and moving the regulating means to the regulating position in operative association with the movement of the feeding means to a feeding stop position in which the feeding means becomes spaced apart from the originals, and a movable holding member for holding the feeding means for rotation and for movement toward and away from the originals, and the interlocking means is provided with a first link member movable in operative association with the movement of the holding member, and a second link member movable in operative association with the movement of the first link member to thereby move the regulating means to the regulating position or the retracted position.

Also, according to the present invention, the first link member or the holding member is formed with a cam shape, and the amount of movement of the regulating means moved through the intermediary of the second link member in conformity with the amount of movement of the holding member is varied by the cam shape.

Also, the image reading apparatus according to the present invention is provided with a guide member provided above the original supporting portion and below the feeding means located at the feeding stop position for guiding the originals fed out by the feeding means, and the cam shape is such a shape that H>h, where H is the amount of movement of the regulating means until the feeding means protrudes downwardly from the guide member through the holding member when it feeds out the originals, and h is the amount of movement of the regulating means after the feeding means has protruded downwardly from the guide member.

Also, the image reading apparatus according to the present invention is provided with an openable and closable cover having the guide member provided on the underside thereof, and the first link member and the second link member are movably mounted on the openable and closable cover, and with the opening operation of the openable and closable cover, the regulating means is moved to the retracted position together with the second link member.

Also, according to the present invention, the second link member is provided with a restraining portion for restraining the holding member to thereby regulate the downward movement of the holding member when the openable and closable cover is opened.

Also, according to the present invention, the openable and closable cover opens the separating portion.

Also, according to the present invention, an image forming apparatus is provided with one of the image reading apparatuses described above, and an image forming portion for forming an image on the basis of image information read by the image reading apparatus.

As described above, according to the present invention, design is made such that when the original is to be fed out, the regulating member is moved to the retracted position in operative association with the movement of the feeding means to the feeding position, and is moved to the regulating position in operative association with the movement of the feeding means to the feeding stop position, whereby there can be provided an image reading apparatus provided with regulating means which is inexpensive and compact and improved in a jam treating property, and an image forming apparatus provided with the same.

### BRIEF DESCRIPTION OF THE DRAWINGS

FIG. 1 schematically shows the construction of an image reading apparatus according to an embodiment of the present invention.

FIG. 2 is a driving block diagram of an original feeder provided in the image reading apparatus.

FIG. 3 is an enlarged view of the surroundings of the sheet feeding portion of the original feeder.

FIG. 4 shows a state when the number of originals set in the sheet feeding portion is small.

FIG. 5 shows a state when the number of originals set in the sheet feeding portion is great.

FIG. 6 is a view for illustrating the present invention.

FIG. 7 is another view for illustrating the present invention.

FIG. 8 shows a state when an openable and closable cover provided in the image reading apparatus has been opened.

FIG. 9 schematically shows the construction of an image forming apparatus provided with the image reading apparatus.

FIG. 10 schematically shows the construction of a conventional image reading apparatus.

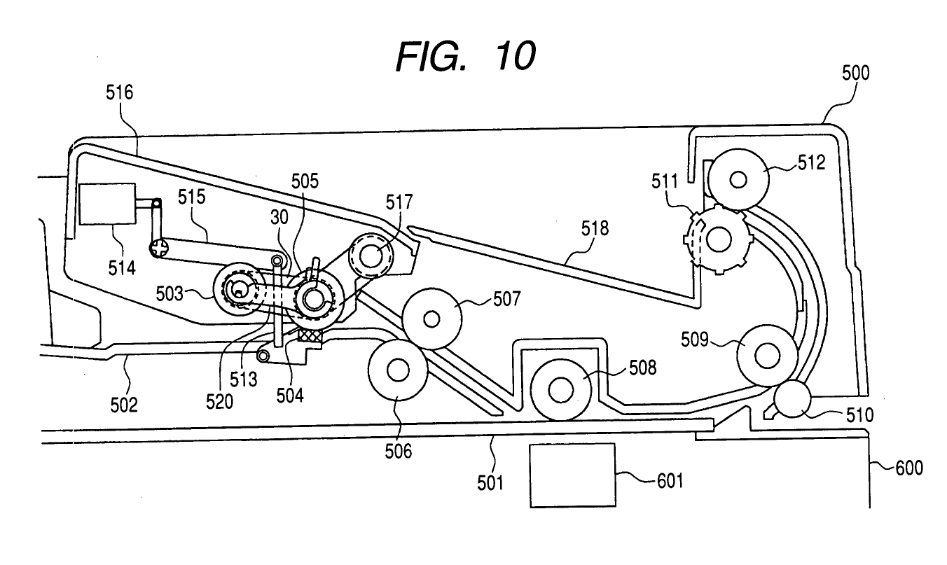

### DESCRIPTION OF THE PREFERRED EMBODIMENTS

An embodiment of the present invention will hereinafter be described in detail with reference to the drawings.

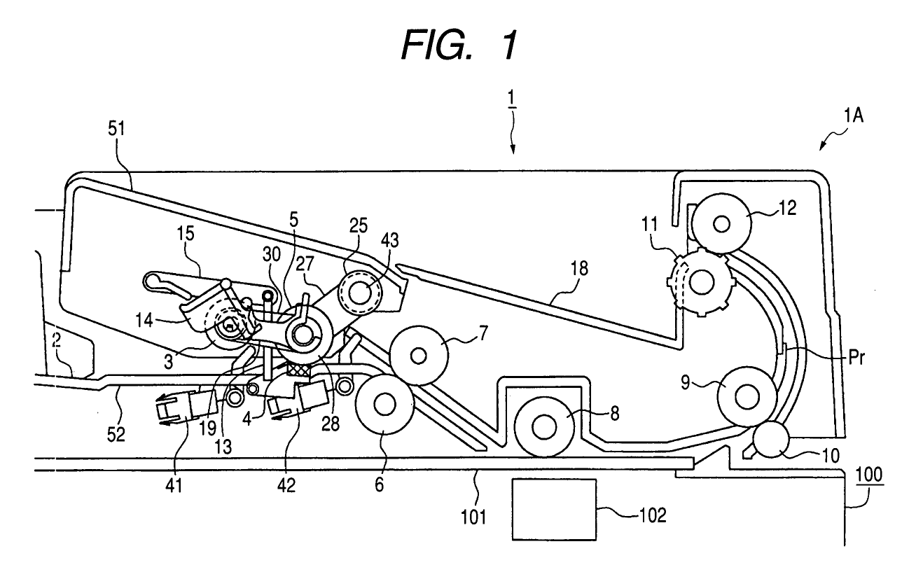

FIG. 1 schematically shows the construction of an image reading apparatus according to the embodiment of the present invention. In the present embodiment, the image reading apparatus is of a type in which an original can be moved in a sub-scanning direction with an optical system fixed to thereby effect reading.

In FIG. 1, the reference character designates an image reading apparatus, the reference numeral 1 denotes an original feeder disposed in the upper portion of the image reading apparatus 1A, and the reference numeral 100 designates a reading housing portion. This reading housing portion 100 is provided with a contact-type image sensor 102 which is image reading means for applying light to the image information surface of an original from an LED array as a light source for illuminating the original, and causing reflected light reflected by the image information surface to be imaged on a sensor element by a SELFOC lens (trademark) to thereby read image information.

Also, the original feeder 1 is provided with an original tray 2 which is an original supporting portion on which the original is placed, a pickup roller 3 which is feeding means provided at a location opposed to the original for movement in a vertical direction, a separating portion provided downstream of the pickup roller 3 and comprised of a separating pad 4 and a separating roller 5, and a pair of registration rollers provided downstream of the separating roller 5 and comprising a registration roller 6 and a driven roller 7 for correcting the skew feeding of the original.

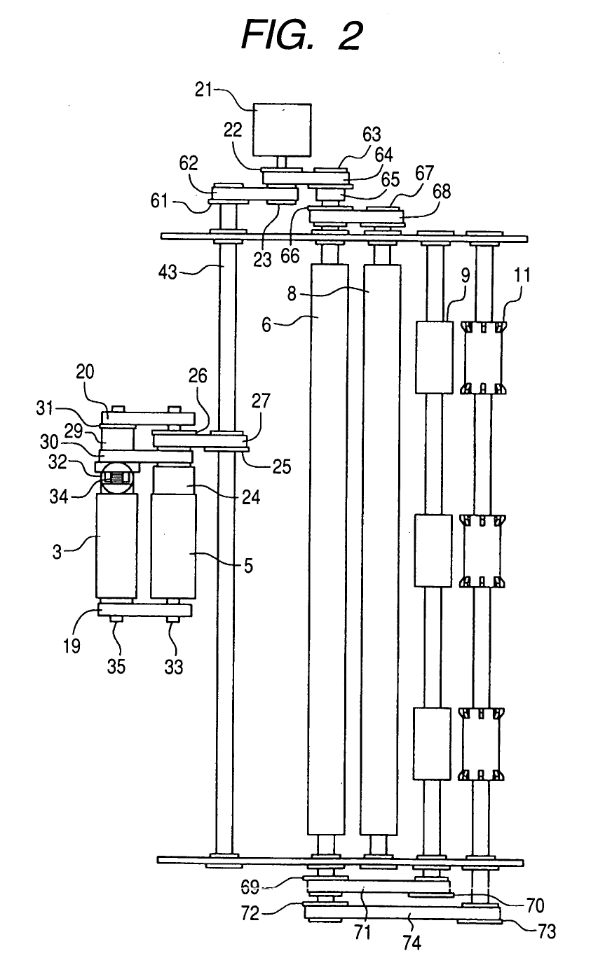

The pickup roller 3 is rotatably mounted on the tip end portions of arms 19 (front) and 20 (rear) which are holding members pivotally (movably) mounted on the rotary shaft 33 of the separating roller 5 shown in FIG. 2 which will be described later, through a shaft 35, and is adapted to contact with or be spaced apart from the original by the vertical pivotal movement of the arms 19 and 20 resulting from the rotation of the separating roller 5.

The reference numeral 41 denotes an original set sensor provided between the pickup roller 3 and the separating roller 5 for detecting the presence or absence of the original on the original tray 2, and the reference numeral 42 designates an ante-registration sensor provided between the separating roller 5 and the pair of registration rollers 6 and 7 for determining an amount of conveyance for the separating roller 5 to convey the original to the pair of registration rollers 6 and 7.

The reference numeral 8 denotes a platen roller provided downstream of the pair of registration rollers 6 and 7 for conveying the original while urging the original against the platen glass 101 of the reading housing portion 100, and downstream of this platen roller 8, there are provided a pair of conveying rollers comprising a conveying roller 9 and a driven roller 10 for discharging the original on the platen glass 101. Further, downstream of the pair of conveying rollers 9 and 10, there are provided a pair of sheet discharging rollers comprising a sheet discharging roller 11 and a driven roller 12 for discharging the original to a discharging tray 18 through a surface reverse path Pr.

Here, by the provision of such a surface reverse path Pr, the discharging tray 18 can be provided above the original tray 2 and therefore, without the discharging tray 18 jumping out to the right and left outer sides of the original feeder 1, the installation space for the original feeder 1 can be made small. The reference numeral 13 designates a shutter, and the reference numeral 14 and 15 denote a second shutter link and a first shutter link for moving the shutter 13 to a position for restraining the original or a position for permitting the entry of the original.

The driving of each roller provided in the original feeder 1 will now be described with reference to FIG. 2.

In FIG. 2, the reference numeral 21 designates a driving motor, and a first pulley 23 mounted on the rotary shaft of this driving motor 21 is connected to a pulley 61 on a sheet feeding drive shaft 43 which is the center of pivotal movement of an openable and closable cover 51 (see FIG. 1) through a timing belt 62. Also, a pulley 25 disposed on the central portion of the sheet feeding drive shaft 43 is connected to a pulley 26 disposed on a separating roller shaft 33 through a timing belt 27.

The pulley 26 disposed on the separating roller shaft 33 is in turn connected to a pulley 29 disposed on a pickup roller shaft 35 through a timing belt 30, whereby the drive of the driving motor 21 is transmitted to the pulley 29 through the pulley 26.

The rotative driving of the pulley 26 is designed to be transmitted to the separating roller 5 through a one-way clutch 24, and design is made such that by the one-way clutch 24, drive is transmitted to the separating roller 5 in a counter-clockwise direction as viewed in FIG. 1, but the drive is not applied in a clockwise direction.

Also, the rotative driving of the pulley 29 disposed on the pickup roller shaft 35 is transmitted through a coupling portion 32 to the pickup roller shaft 35 of the pickup roller 3 rotatably supported on the tip end portions of the arm (front) 19 and arm (rear) 20 pivotally movable about the separating roller shaft 33.

On the pickup roller shaft 35, a friction member 31 is provided between the pulley 29 and the arm 20, and this friction member 31 is biased toward the arm 20 side by a compression spring (not shown). Thereby, the pulley 26 is rotated in a counter-clockwise direction and the pulley 29 is rotated in a counter-clockwise direction through the intermediary of the timing belt 30, whereupon the arm 20 and the arm 19 are pivotally moved in a counter-clockwise direction (downward direction) about the separating roller shaft 33 by the sliding load of the friction member 31 and as the result, the pickup roller 3 comes into contact with the original, whereupon the pickup roller 3 is rotated in a counter-clockwise direction against the sliding load of the friction member 31.

Also, when the pulley 26 is rotated in a clockwise direction and the pulley 29 is rotated in a clockwise direction through the intermediary of the timing belt 30, the arm 20 and the arm 19 are pivotally moved in a clockwise direction (upward direction) about the separating roller shaft 33 by the sliding load of the friction member 31 and as the result, the pickup roller 3 becomes spaced apart from the original.

Description will now be made of a driving system for the registration roller 6, the platen roller 8, the conveying roller 9 and the sheet discharging roller 11.

A second pulley 22 is mounted on the rotary shaft of the driving motor 21, and this second pulley 22 is connected to a pulley 63 through a timing belt 64. Also, a one-way clutch 65 provided on the shaft of the registration roller 6 is connected to the pulley 63, and only the drive in a direction opposite to the driving direction of the separating roller 5 is transmitted to the registration roller 6 by the one-way clutch 65.

That is, during the forward rotation of the driving motor 21, the separating roller 5 receives drive in a counter-clockwise direction, but the drive is not transmitted to the registration roller 6. Also, during the reverse rotation of the driving motor 21, the drive is not transmitted to the separating roller 5, but yet the drive is transmitted to the registration roller 6 in a clockwise direction.

Also, a pulley 66 is provided on one end of the shaft of the registration roller 6, and this pulley 66 is connected to a pulley 67 on the shaft of the platen roller 8 through a timing belt 68. Further, two pulleys 69 and 72 disposed on the other end of the shaft of the registration roller 6 are connected through timing belts 71 and 74, respectively, to a pulley 70 provided on the shaft 9a of the conveying roller 9 and a pulley 73 provided on the shaft 11a of the sheet discharging roller 11, respectively. Thereby, the drive of the driving motor 21 is transmitted to the conveying roller 9 and the sheet discharging roller 11.

The original conveying operation of the original feeder 1 provided with such a driving system will now be described with reference to FIG. 1.

When originals are set on the original tray 2 with the image surface thereof facing down, the original set sensor 41 is turned on, and by a detection signal from this original set sensor 41, a control portion (not shown) detects the presence of the originals on the original tray 2. When here, a start button, not shown, is depressed, the driving motor 21 is first rotated in a forward direction by a driving signal from the control portion, and together therewith, the pickup roller 3 is lowered and comes into contact with the originals, whereafter the pickup roller 3 is rotated in a counter-clockwise direction which is an original conveying direction, thereby conveying the originals to the separating portion 4, 5.

Next, the originals are separated one by one in this separating portion 4, 5, and the separated original is dashed against the pair of registration rollers 6 and 7 which are not being driven, whereafter the original forms a predetermined amount of loop, whereupon the driving motor 21 is stopped to thereby once stop the conveyance. Thereafter, the driving motor 21 is rotated in a reverse direction by the driving signal from the control portion, whereby the registration roller 6, the platen roller 8, the conveying roller 9 and the sheet discharging roller 11 are rotated.

Thereby, the original is conveyed while being in close contact with the platen glass 101, and is exposed to light by illuminating means, not shown, whereby the reading of the original is effected. Thereafter, the original passes the platen roller 8, whereupon the reading is terminated, and the driving motor 21 is stopped, whereby the first original is stopped while being nipped between the pair of sheet discharging rollers 11 and 12.

Next, the driving motor 21 is again rotated in the forward direction by the driving signal from the control portion to thereby feed the second original, whereafter like the first original, the second original is dashed against the pair of registration rollers 6 and 7 being at a halt, whereby a predetermined amount of loop is obtained and the driving motor 21 is stopped to thereby once stop the conveyance. Thereafter, the driving motor 21 is again rotated in the reverse direction by the driving signal from the control portion and the registration roller 6, the platen roller 8, the conveying roller 9 and the sheet discharging roller 11 are rotated, whereupon the reading of the second original is effected and the first original is discharged onto the sheet discharging tray 18 by the pair of sheet discharging rollers 11 and 12.

The above-described operation is continued and when the original set sensor 41 is turned off during the reading of the last original, the control portion detects the exhaustion of the originals on the original tray 2. When the exhaustion of the originals is detected in this manner, the driving of the driving motor 21 is continued still after the termination of the reading, whereby the last original is discharged onto the sheet discharging tray 18 by the pair of sheet discharging rollers 11 and 12.

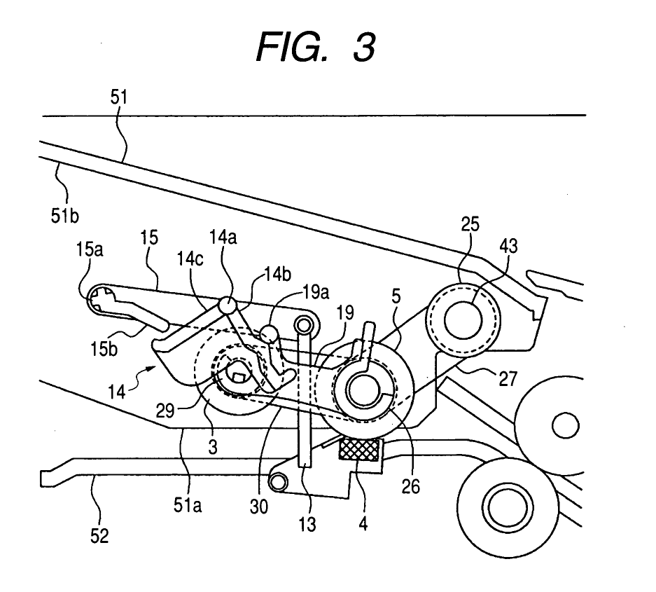

FIG. 3 is a cross-sectional view of the surroundings of the sheet feeding portion, and as shown in FIG. 3, the shutter 13 which is regulating means is pivotally mounted on the end of the pivotal movement of the first shutter link 15 which is a second link member, and is located between an openable and closable cover rib 51a which is a guide member provided on the underside of the openable and closable cover 51 forming an upper conveying guide and a lower conveying guide 52 present on the extension of the original tray 2.

The openable and closable cover 51 is pivotally movable in a vertical direction about the sheet feeding drive shaft 43, and design is made such that when this openable and closable cover 51 is opened by being upwardly pivotally moved, the pad 4 and the separating roller 5 become spaced apart from each other.

Also, the first shutter link 15 is pivotally (movably) on the openable and closable cover 51 by a pivotal movement center 15a, and the second shutter link 14 which is a first link member is pivotally (movably) mounted on the openable and closable cover 51 by a pivotal movement center 14a.

When as already described, the driving motor 21 is rotated in the forward direction and the separating roller 5 and the pickup roller 3 are rotated in the counter-clockwise direction and the arm 19 is pivotally moved in the counter-clockwise direction, the cam surface 14b of the second shutter link 14 is pressed and depressed by the lever portion 19a of the arm 19 with the pivotal movement of this arm 19 because the arm 19 is provided with the lever portion 19a.

Thereby, the second shutter link 14 is pivotally moved in the clockwise direction. This second shutter link 14 is provided with a lever 14c, and when the second shutter link 14 is thus pivotally moved, the lever 15b of the first shutter link 15 is pushed up by the lever 14c of the second shutter link 14c, whereby the first shutter link 15 is pivotally moved in the counter-clockwise direction.

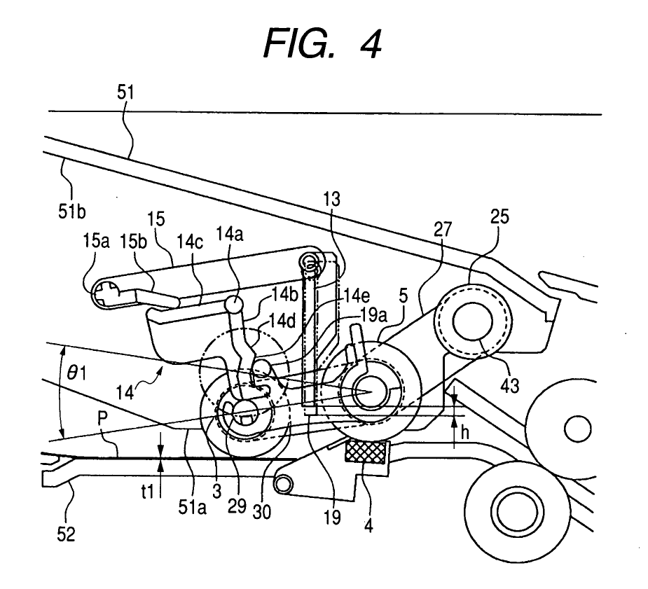

When the first shutter link 15 is thus pivotally moved in the counter-clockwise direction, the shutter 13 is raised upwardly from the original regulating position and is retracted to above the openable and closable cover rib 51a, as shown in FIG. 4. Thereby, even if the sheet feeding operation is performed thereafter, it will never happen that the shutter 13 hampers the feeding-out of the original. When thereafter, the driving motor 21 is rotated in the reverse direction, the arm 19 is rotated in the clockwise direction and together therewith, the shutter 13 falls with the gravity of the shutter 13 and returns to a position shown in FIG. 3.

In case where as described above, the original is fed out by interlocking means constituted by the first shutter link 15, the second shutter link 14 and the arm 19, the shutter 13 is moved to the retracted position in operative association with the movement of the pickup roller 3 to the feeding position in which it contacts with the original, and the shutter 13 is moved to the regulating position in operative association with the movement of the pickup roller 3 to the feeding stop position in which it is spaced apart from the original, whereby driving means (such as a solenoid) exclusively for moving up and down the shutter can be disused to thereby achieve a reduction in cost.

Further, because of a construction in which two systems of transmitting means are not used, but the two link members 14 and 15 are simply added, it is possible to achieve the simplification of the driving system, the curtailment of the number of parts such as gears, timing belts and shafts, and the saving of space (downsizing).

Now, FIG. 4 shows a state when the number of originals set on the original tray 2 is small (the thickness of a bundle is small). When like this, the thickness t1 of the bundle of set originals P is small; the pickup roller 3 is lowered by the angle θ1 from a dots-and-dash line position to a solid line position in FIG. 4.

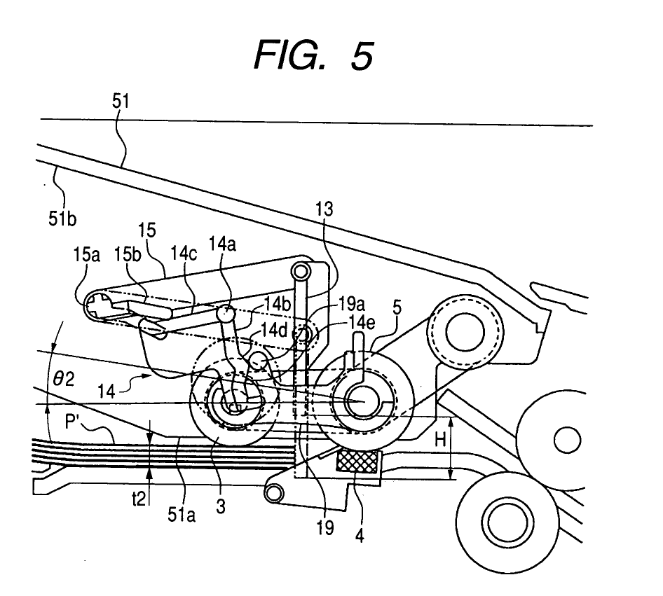

On the other hand, FIG. 5 shows a state when the number of originals set on the original tray 2 is great (the thickness of a bundle is great). When like this, the thickness t2 of the bundle of set originals P′ is great, the pickup roller 3 is pivotally moved by the angle θ2 from a dots-and-dash line position (retracted position) to a solid line position in FIG. 5.

That is, when the thickness of the bundle of set originals is small (t1), the amount of pivotal movement (the amount of downward movement) of the pickup roller 3 becomes great (θ1), and when the thickness of the bundle is great (t2), the amount of pivotal movement (the amount of downward movement) of the pickup roller 3 becomes small (θ2).

Accordingly, when the bundle of originals P is thick (t2), the amount of pivotal movement of the arm 19 in the counter-clockwise direction becomes small and along therewith, the amounts of pivotal movement of the second shutter link 14 and the first shutter link 15 also become small and therefore, the amount of upward retraction of the shutter 13 becomes small.

In the present embodiment, however, as shown in link 14 is formed with a cam shape 14d of a steep gradient so that even when the amount of pivotal movement of the arm 19 is small as described above, the shutter 13 can be retracted upwardly from the openable and closable cover rib 51a.

When as described above, the cam surface 14b of the second shutter link 14 is formed with the cam shape 14d of a steep gradient and the arm 19 is pivotally moved in the counter-clockwise direction, the lever prition 19a of the arm 19 pressed this cam shape 14d of a steep gradient, whereby the second shutter link 14 and the first shutter link 15 can be greatly pivotally moved.

Thereby, the shutter 13 can be sufficiently retracted even when the amount of pivotal movement of the arm 19 is small. In FIG. 5, the dots-and-dash line indicates the original regulating position of the shutter 13, and H indicates a distance over which the shutter 13 has been moved to a position indicated by a solid line above the openable and closable cover rib 51a by the construction as described above until the pickup roller 3 protrudes downwardly from the openable and closable cover rib 51a through the intermediary of the arm 19.

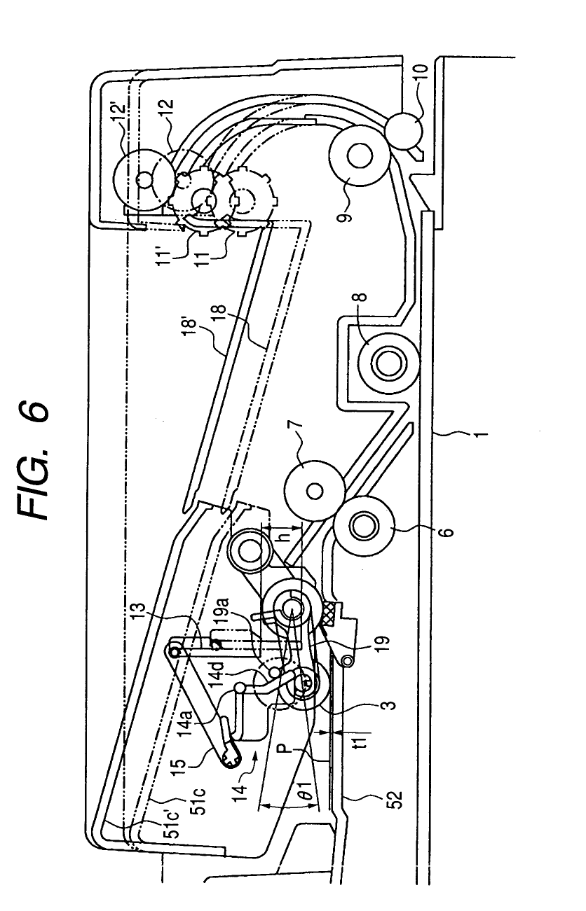

Now, after the shutter 13 has been retracted to above the openable and closable cover rib 51a as described above, the amount of retraction of the shutter 13 may be small. FIG. 6 shows a case where the cam surface 14b of the second shutter link 14 is formed with only the cam shape 14d of a steep gradient, and in the case of such a construction, the amount of retraction (movement) h of the shutter 13 after it has cleared the openable and closable cover rib 51a becomes great.

When the amount of retraction h of the shutter 13 becomes great as described above, the top surface 51c of the openable and closable cover 51 must be raised to a position indicated by 51c′ in FIG. 6 so that the uppermost portions of the shutter 13 and the first shutter link 15 may not collide with the top surface 51c. Also, along with this, the sheet discharging tray 18 and the pair of sheet discharging rollers 11 and 12 must also be raised to positions indicated by 18′, 11′ and 12′, respectively, in FIG. 6, and this results in the bulkiness of the image reading apparatus and the great distance of the conveying path, and also affects productivity.

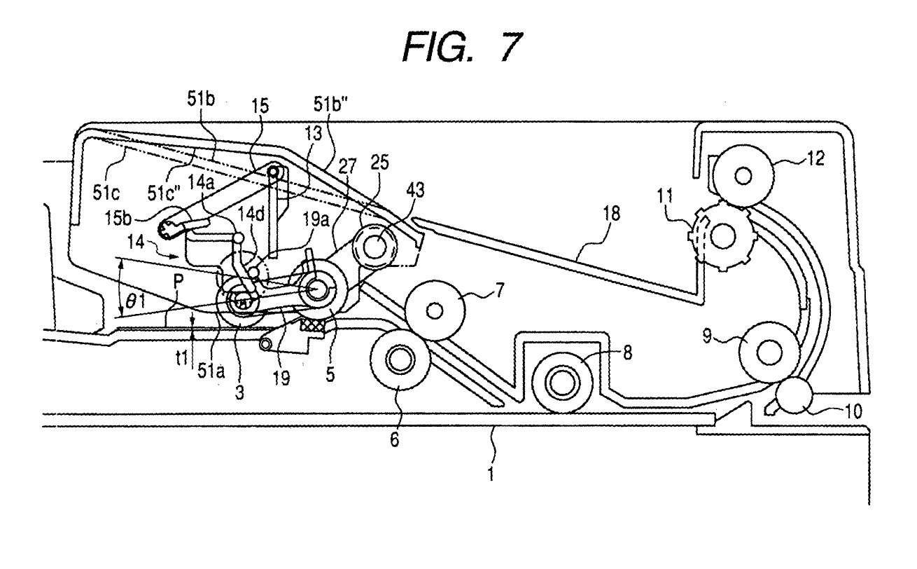

In order not to reduce productivity, it is desirable to adopt a construction in which the location of the pair of sheet discharging rollers 11 and 12 is not raised (the distance of the conveying path is not lengthened). When the location of the pair of sheet discharging rollers 11 and 12 is not raised as described above, it is necessary to make a discharged sheet stacking surface 51b relatively low, but sometimes the discharged sheet stacking surface 51b cannot be made low depending on the disposition of the shutter 13 and the first shutter link 15 or the like. In that case, as shown in FIG. 7, the slope of the discharged sheet stacking surface 51b″ of the openable and closable cover 51 becomes steep as compared with the conventional discharged sheet stacking surface 51b and therefore, a discharged sheet stacking property is aggravated.

So, in the present embodiment, as shown in FIG. 4, below the cam shape 14d of the second shutter link 14, there is formed a cam shape 14e having a gradient opposite in direction to the cam shape 14d. Design is made such that after below the cam shape 14d, the cam shape 14e having a gradient opposite in direction thereto has been formed as described above, and the shutter 13 has been retracted to above the openable and closable cover rib 51a, the lever portion 19a of the arm 19 presses this cam shape 14e, whereby even if thereafter the arm 19 is pivotally moved, the amounts of pivotal movement of the second shutter link 14 and the first shutter link 15 can be made small.

Thereby, the amount of retraction (movement) h of the shutter 13 to the openable and closable cover rib 51a and so on can be made small, and without the height of the openable and closable cover top surface 51c being increased, the uppermost portions of the shutter 13 and the first shutter link 15 can be prevented from colliding with the openable and closable cover top surface 51c.

As described above, the cam surface of the second shutter link 14 is formed with the cam shape 14d of a steep gradient and the cam shape 14e having a gradient opposite in direction to the cam shape 14d, whereby when the original is to be fed out, the amount of movement H of the shutter 13 until the pickup roller 3 protrudes downwardly from the openable and closable cover rib 51a through the intermediary of the arm 19 can be made great. Thereby, the shutter 13 can be sufficiently retracted even when the amount of downward movement of the pickup roller 3 is small as when the thickness of the bundle of originals is great.

Also, the amount of movement h of the shutter 13 after the pickup roller 3 has protruded downwardly from the openable and closable cover rib 51a can be made small. That is, design is made such that due to the two cam shapes 14d and 14e, the relation between H and h becomes H>h and therefore, the amount of retraction of the shutter 13 is made great within a range which can cope with even the case where the thickness of the bundle is great, and the amount of retraction is made small when the shutter 13 has been sufficiently retracted, whereby without the top surface of the openable and closable cover 51 being heightened, the first shutter link 15 and the second shutter link 14 can be disposed. Accordingly, the bulkiness and reduced productivity of the image reading apparatus can be prevented and further, a reduction in the discharged sheet stacking property of the openable and closable cover 51 serving also as the discharged sheet stacking surface can be prevented.

While in the foregoing, description has been made of the case where the second shutter link 14 is formed with the cam surface, a similar effect can also be obtained even if the lever portion 19a of the arm 19 is formed with a cam shape of such a construction as described above.

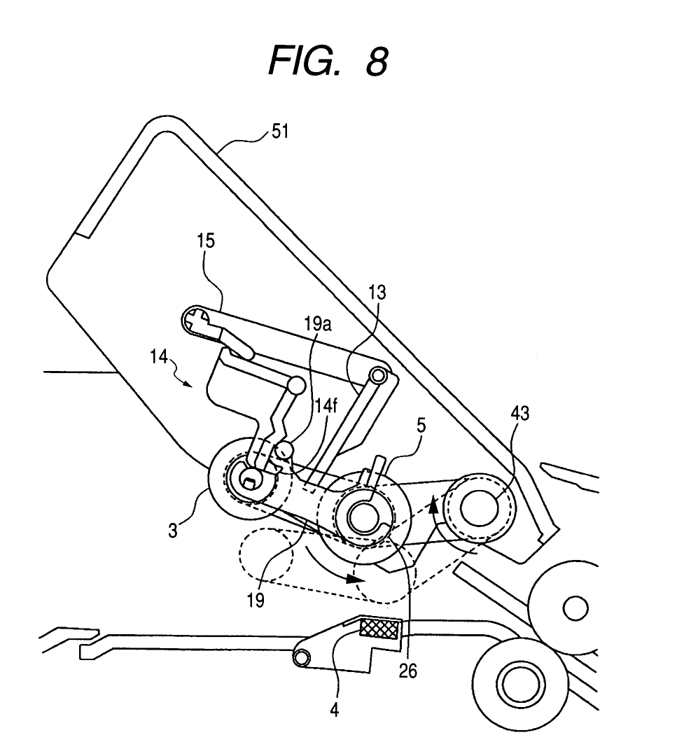

Now, when the original in the sheet feeding portion is jammed as already described, the openable and closable cover 51 is pivotally moved in a clockwise direction about the sheet feeding drive shaft 43, as shown in FIG. 8, and the pressure contact between the separating roller 5 and the separating pad 4 is released, whereby the original jammed in the sheet feeding portion can be easily pulled out leftwardly.

When as described above, the openable and closable cover 51 is pivotally moved in a clockwise direction about the sheet feeding drive shaft 43, the pulley 25 on the sheet feeding drive shaft is relatively rotated in a counter-clockwise direction. When the pulley 25 is thus rotated in the counter-clockwise direction, the pulley 29 is rotated in a counter-clockwise direction through the intermediary of the timing belt 27, the pulley 26 and the timing belt 30, and together therewith, as already described, the arm 19 is pivotally moved in the counter-clockwise direction by the sliding load of the friction member 31 and as the result, as shown in FIG. 8, the shutter 13 is upwardly retracted.

Thereby, it never happens that the shutter 13 hangs down with the aid of gravity when the openable and closable cover 51 is opened and a jammed original is pulled out, and the shutter 13 can be prevented from being caught by the original to thereby hamper the pulling-out of the original.

On the other hand, there is a case where at this time, the arm 19 is rotated too much in a counter-clockwise direction and the pickup roller 3 tends to be lowered. In the present embodiment, however, as shown in FIG. 8, a stopper portion 14f which is a restraining portion is provided on the lower end portion of the second shutter link 14, and when the pickup roller 3 tends to be lowered as described above, the lever portion 19a of the arm 19 is adapted to be restrained by this stopper portion 14f. Thereby, it never happens that the pickup roller 3 is lowered too much and hampers jam treatment.

As described above, the shutter 13 can be upwardly retracted in operative association with the pivotal movement of the openable and closable cover 51 and therefore, when the original jammed in the sheet feeding portion is to be pulled out, the jammed original can be pulled out without being struck against the shutter 13, whereby the original can be prevented from being damaged when it is pulled out.

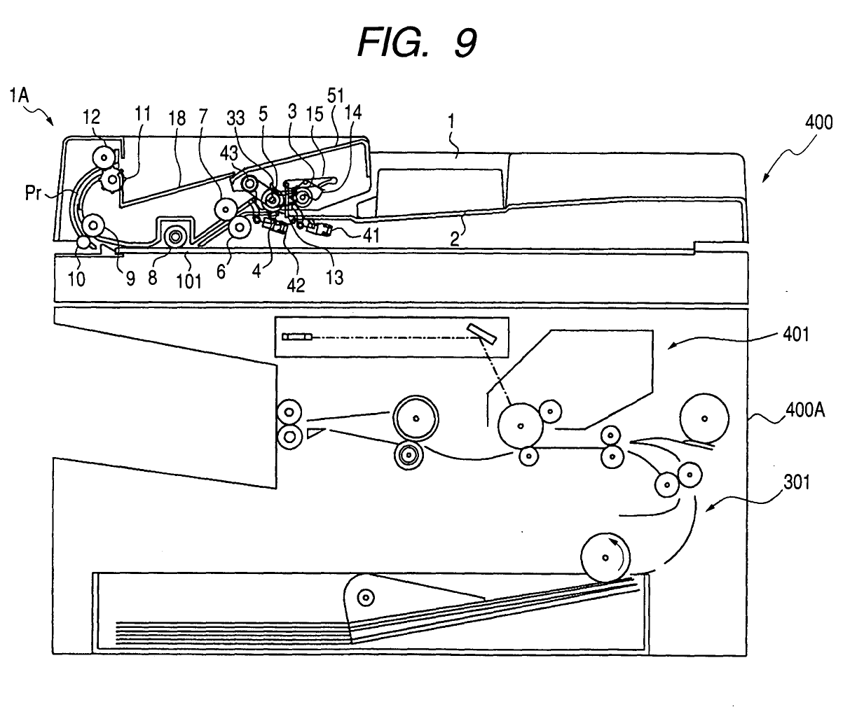

Now, while the construction of the single body of an image reading apparatus has hitherto been described, of course the present invention can also be applied to an image reading apparatus 1 provided on an image forming apparatus (digital copying machine) as shown in FIG. 9.

In FIG. 9, the reference numeral 400 designates a digital copying machine, the reference character 400A denotes a digital copying machine main body (hereinafter referred to as the apparatus main body), the reference numeral 401 designates an image forming portion disposed in the central portion of the apparatus main body 400A, and the reference numeral 301 denotes a sheet feeding portion for conveying a sheet to the image forming portion 401.

What is claimed is:

1. A sheet feeding apparatus comprising:
a sheet supporting portion on which a sheet is placed;
feeding means, provided above said sheet supporting portion, for coming into and out of contact with the sheet placed on said sheet supporting portion, and for feeding out the sheet;
a separating portion for separating the sheet fed out by said feeding means and feeding the sheet one by one;
regulating means provided between said separating portion and said feeding means and movable between a regulating position in which said regulating means regulates the sheet placed on said sheet supporting portion coming to said separating portion before a feeding operation by said feeding means and a retracted position in which said regulating means does not hamper the feeding of the sheet during the feeding operation of said feeding means;
interlocking means for moving said regulating means to said retracted position in operative association with the movement of said feeding means to a feeding position in which said feeding means is in contact with the sheet when said feeding means feeds out the sheet, and moving said regulating means to said regulating position in operative association with the movement of said feeding means to a feeding stop position in which said feeding means is out of contact with the sheet; and
a movable holding member for holding said feeding means for rotation and for bringing said feeding means into and out of contact with the sheet,
wherein said interlocking means includes a first link member movable in operative association with the movement of said holding member, and a second link member movable in operative association with the movement of said first link member to thereby move said regulating means to said regulating position or said retracted position.

2. A sheet feeding apparatus according to claim 1, wherein said first link member or said holding member is provided with a cam shape, and an amount of movement of said regulating means moved through the intermediary of said second link member in accordance with the amount of movement of said holding member is varied by said cam shape.

3. A sheet feeding apparatus according to claim 2, further comprising a guide member for guiding the sheet fed out by said feeding means, wherein said cam shape is such a shape that H>h, where H is the amount of movement of said regulating means until said feeding means protrudes downwardly from said guide member through said holding member when said feeding means feeds out the sheet, and h is the amount of movement of said regulating means after said feeding means has protruded downwardly from said guide member.

4. An image reading apparatus comprising:
image reading means for reading an image of an original; and
an original feeder for feeding the original from an original supporting portion, on which the original is placed, to said image reading means,
wherein said original feeder comprising:
feeding means, provided above said original supporting portion, for coming into and out of contact with the original placed on said original supporting portion and for feeding out the original;
a separating portion for separating the original fed out by said feeding means and feeding the original one by one to said image reading means;
regulating means provided between said separating portion and said feeding means and movable between a regulating position in which said regulating means regulates the original placed on said original supporting portion coming to said separating portion before a feeding operation by said feeding means and a retracted position in which said regulating means does not hamper the feeding of the original during the feeding operation of said feeding means;
interlocking means for moving said regulating means to said retracted position in operative association with the movement of said feeding means to a feeding position in which said feeding means is in contact with the original when said feeding means feeds out the original, and moving said regulating means to said regulating position in operative association with the movement of said feeding means to a feeding stop position in which said feeding means is out of contact with the original; and
a movable holding member for holding said feeding means for rotation and for bringing said feeding means into and out of contact with the original,
wherein said interlocking means includes a first link member movable in operative association with the movement of said holding member, and a second link member movable in operative association with the movement of said first link member to thereby move said regulating means to said regulating position or said retracted position.

5. An image reading apparatus according to claim 4, wherein said first link member or said holding member is provided with a cam shape, and an amount of movement of said regulating means moved through the intermediary of said second link member in accordance with the amount of movement of said holding member is varied by said cam shape.

6. An image reading apparatus according to claim 5, further comprising a guide member provided above said original supporting portion and below said feeding means located at said feeding stop position for guiding the original fed out by said feeding means, wherein said cam shape is such a shape that H>h, where H is the amount of movement of said regulating means until said feeding means protrudes downwardly from said guide member through said holding member when said feeding means feeds out the original, and h is the amount of movement of said regulating means after said feeding means has protruded downwardly from said guide member.

7. An image reading apparatus according to claim 6, further comprising an openable and closable cover having said guide member provided on an underside of said openable and closable cover, wherein said first link member and said second link member are movably mounted on said openable and closable cover, and with an opening operation of said openable and closable cover, said regulating means is moved to said retracted position together with said second link member.

8. An image reading apparatus according to claim 7, wherein said second link member is provided with a restraining portion for restraining said holding member to thereby regulate the downward movement of said holding member when said openable and closable cover is opened.

9. An image reading apparatus according to claim 7, wherein said openable and closable cover opens said separating portion.

10. An image forming apparatus comprising:
an image reading apparatus as recited in any one of claims 4 to 9; and
an image forming portion for forming an image on the basis of image information read by said image reading apparatus.
